(19) United States
(12) Patent Application Publication
(10) Pub. No.: US 2023/0410169 A1
(43) Pub. Date: Dec. 21, 2023

(54) SYSTEM AND METHOD FOR BUYER AND SELLER CONNECTING, MATCHING, AND COMMUNICATION

(71) Applicants: Persio De Luca Neto, Lake Forest, CA (US); Vanessa Feghali De Luca, Lake Forest, CA (US)

(72) Inventors: Persio De Luca Neto, Lake Forest, CA (US); Vanessa Feghali De Luca, Lake Forest, CA (US)

(21) Appl. No.: 17/841,393

(22) Filed: Jun. 15, 2022

(51) Int. Cl. G06Q 30/06; G06Q 30/08

(52) U.S. Cl. CPC G06Q 30/0611; G06Q 30/08

(57) ABSTRACT

A system and method for buyer and seller matching and communication includes a buyer computer, a seller computer, and a server communicatively connected to each other through a network; a memory storing an application; a processor which executes the application to cause the system to: receive request parameters; receive first listing parameters; generate a request based on the request parameters; generate a first listing based on the first listing parameters; determine that the request matches the listing by comparing the request parameters with the first listing parameters; and notify a buyer associated with the request or a first seller associated with the first listing, or both one the buyer and the first seller, that the request matches the first listing. Parameters are stored in one or more databases. Matches between requests and listings are determined by calculating a matching percentage between the request parameters and the listing parameters and to comparing the matching percentage to a threshold.

### CROSS-REFERENCE TO OTHER APPLICATIONS

This application is a Non-Provisional Application that claims the benefit of Provisional Patent Application No. 63/175,290, filed on Apr. 15, 2021, and incorporated herein by reference in its entirety.

### TECHNICAL FIELD

The features or aspects generally relate to internet sales/trade communications and planning, and more particularly relate to online connection and/or matching of specific buyer requirements with seller online listed offers that meet the requirements while also allowing sellers to include new offers to fulfill those requests and enabling communications to complete transactions.

### BACKGROUND

Despite the currently available internet and communication technologies, buyers often cannot find products they want and sometimes at a price they want or need. Similarly, sellers do not know the real demand of the market online. Sellers may know the number of closed sales of one or more of their products or services and, to a limited extent, the closed sales of competitors and others. However, sellers do not know the number of potential buyers or the terms on which they want to buy the products.

Buyers do not have a solution that allows online publishing of product and/or service requests with specifics requirements such as price, conditions, and expiration date of the request. Sellers cannot see, know, or have access to the buyer's requirements, and consequently cannot make customized offers to fit the requirements or include new product listings for a specific request. On other solutions, buyers must run manual searches each time they want to find products, and if they do not find a product or service that matches all requirements or desired features, the only recourses available are to save a search or receive an alert, but then sellers will never know about this potential buyer and cannot make customized offers for the requests.

### SUMMARY

This summary is provided to introduce a variety of concepts and/or aspects in a simplified form that is further disclosed in the detailed description, below. This summary is not intended to identify key or essential inventive concepts of the claimed subject matter, nor is it intended for determining the scope of the claimed subject matter.

The aspects provided herein relate to systems and processes for buyer and seller connecting, matching and communication in the context of online transactions via an online matching system. The systems and processes operate in different manners according to the user role, generally buyer or seller. Processes include a buyer entering and the online matching system receiving request parameters, a seller entering and the online matching system receiving first listing parameters, generating a request based on the request parameters, generating a first listing based on the first listing parameters, determining that the request matches the listing by comparing the request parameters with the first listing parameters, and notifying a buyer associated with the request or a first seller associated with the first listing, or both one the buyer and the first seller, that the request matches the first listing. Determining that the request matches the listing by comparing the request parameters with the listing parameters comprises calculating a matching percentage between the request parameters and the listing parameters and comparing the matching percentage to a threshold.

According to one or more aspects, the systems and processes store the request parameters and the first listing parameters in one or more databases.

According to one or more aspects, the systems and processes receive second listing parameters, third listing parameters, and customized third listing parameters that allow exchanges; generate a second listing based on the second listing parameters; generate a third listing based on the third listing parameters; generate a customized listing based on the customized third listing parameters; and sends a link to a second seller associated with the second listing, wherein the link points to the customized listing, and wherein the customized third listing parameters match the second listing parameters.

According to one or more aspects, the systems and processes receive second listing parameters that allow exchanges; receiving third listing parameters that allow exchanges; generating a second listing based on the second listing parameters; generating a third listing based on the third listing parameters; and sending a link to a second seller associated with the second listing, wherein the link points to the third listing, and wherein the third listing parameters are customized to match the second listing parameters.

According to one or more aspects, the first listing is a customized listing. The request and/or the first listing are posted and made available through the online matching system.

According to one or more aspects, the systems and processes generate a customized listing having at least one customized listing parameter that is different from at least one corresponding parameter of the first listing parameters.

According to one or more aspects, the systems and processes display a screen comprising at least one of the following: a request dashboard, a direct buy dashboard, a selling dashboard, and an exchange dashboard. According to one or more aspects, the systems and processes display a screen comprising at least one of the following: a request dashboard and a request button, a direct buy dashboard and a direct buy button, a selling dashboard and a selling button, and an exchange dashboard and an exchange button. According to one or more aspects, the systems and processes display a screen comprising at least one of the following a request button including a request dashboard, a direct buy button including a direct buy dashboard, a selling button including a selling dashboard, and an exchange button including an exchange dashboard.

According to one or more aspects, an online matching system comprises a buyer computer, a seller computer, and a server communicatively connected to each other through a network; a memory storing an application; a processor which executes the application to cause the system to: receive request parameters; receive first listing parameters; generate a request based on the request parameters; generate a first listing based on the first listing parameters; determine that the request matches the listing by comparing the request parameters with the first listing parameters; and notify a buyer associated with the request or a first seller associated with the first listing, or both one the buyer and the first seller, that the request matches the first listing.

According to one or more aspects, a computer readable medium has computer readable instructions executable by a processor which, when executed, perform a process for generating requests and listings, the process comprising receiving request parameters, receiving first listing parameters, generating a request based on the request parameters, generating a first listing based on the first listing parameters, determining that the request matches the listing by comparing the request parameters with the first listing parameters, and notifying a buyer associated with the request or a first seller associated with the first listing, or both one the buyer and the first seller, that the request matches the first listing.

### BRIEF DESCRIPTION OF THE DRAWINGS

A complete understanding of the present features or aspects and the advantages and features thereof will be more readily understood by reference to the following detailed description when considered in conjunction with the accompanying drawings wherein:

FIG. 1-A illustrates a block diagram of a system for online matching of buyer requirements with seller listings, according to one or more aspects.

FIG. 1-B illustrates a block diagram of a computer, according to one or more aspects.

FIG. 2 illustrates a buyer flowchart, according to one or more aspects.

FIG. 3 illustrates a seller flowchart, according to one or more aspects.

FIG. 4 illustrates an exchange flowchart, according to one or more aspects.

FIG. 5 illustrates a device displaying a home screen, according to one or more aspects.

FIG. 6-A illustrates a device displaying a matching feature list screen, according to one or more aspects.

FIG. 6-B illustrates a device displaying a matching feature detail screen, according to one or more aspects.

Like reference numerals refer to like parts throughout the several views of the drawings.

### DETAILED DESCRIPTION

Any specific details of features or aspects are used for demonstration purposes only, and no unnecessary limitations or inferences are to be understood therefrom.

Before describing in detail exemplary aspects, it is noted that the aspects reside primarily in combinations of components and procedures related to the system and/or apparatus. Accordingly, the system and/or apparatus components have been represented where appropriate by conventional symbols in the drawings, showing only those specific details that are pertinent to understanding the aspects of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship, or order between such entities or elements. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary aspects of the inventive concepts defined in the appended claims. Hence, specific steps, process order, dimensions, component connections, and other physical characteristics relating to the aspects disclosed herein are not to be considered as limiting, unless the claims expressly state otherwise. The use or mention of any single element contemplates a plurality of such element, and the use or mention of a plurality of any element contemplates a single element (for example, “a device” and “devices” and “a plurality of devices” and “one or more devices” and “at least one device” contemplate each other), regardless of whether particular variations are identified and/or described, unless impractical, impossible, or explicitly limited.

Shown throughout the figures, the exemplary and non-limiting aspects generally relate to internet sales/trade communications and planning, and more particularly relate to systems and processes for online matching of specific buyer requirements with seller offers or listings that meet the requirements and enabling communications to complete transactions. The characteristics, features, elements, and/or aspects (any and/or all referred to as “aspects”) described and/or referenced in this specification may be applied to matching buyer requests to seller listings, matching seller listings to buyer requests, matching listings and/or requests for exchanges, and/or enabling communications between buyers, sellers, and/or exchanging parties. Any examples, the characteristics, features, elements, and/or aspects described and/or referenced in this specification are nonlimiting and can or may be applied to the referred systems and processes for online matching of specific buyer requirements with seller offers that meet the requirements and enabling communications to complete transactions, and/or the like.

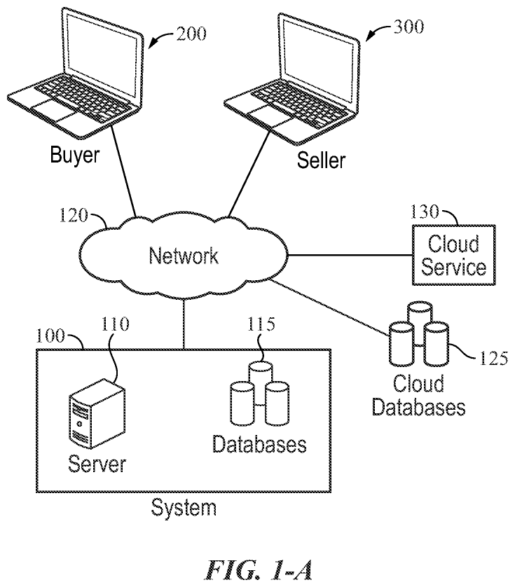

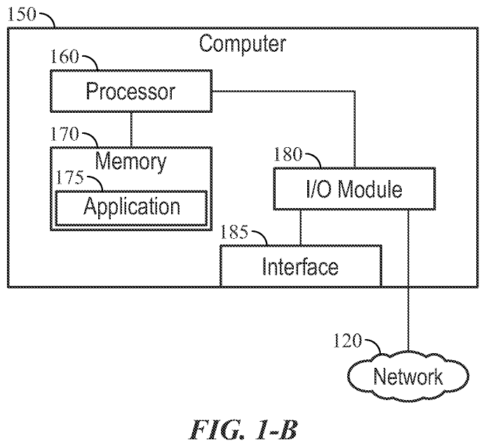

FIG. 1-A illustrates a block diagram of a system for online matching of specific buyer requirements with seller offers that meet the requirements and enabling communications to complete transactions, or online matching system 100. The online matching system 100 includes a server 110 and a database or one or more databases 115. The server connects via wire and/or wirelessly to a network 120. A buyer computer 200, a seller computer 300, cloud databases 125, and a cloud service 130 connect to each other and/or to the online matching system 100 via wired and/or wireless connection to the network 120.

FIG. 1-B shows a block diagram of a computer 150, according to one or more aspects. Various features described within FIGS. 1-A and/or 1-B may generally complement the description of the other figures of the present disclosure. Moreover, a computing device such as the computer 150 can be or be embedded in and/or integrated with another device, e.g., a mobile telephone, a smartphone, a tablet, a laptop, desktop computer, virtual machine, virtual server, serverless application (“serverless” contemplating the absence of servers, the presence of non-managed servers, cloud-based serverless services, and/or the common meaning of “serverless” as used by those with ordinary skill in the art), virtual computer, cloud computer instance, electronic medical devices, appliances, household appliances, a digital camera, a personal digital assistant (PDA), a mobile audio or video player, a game console, VR glasses, augmented reality glasses, wearable gadgets (smartwatch, air pods, and so forth), any global navigation system and/or global navigation satellite system transmitter/receiver/hardware/firmware/software (such as Global Positioning System (GPS), GLONASS, Galileo, BeiDou, QZSS, IRNSS/NavIC, or other global positioning, location, and/or navigation technology), a portable storage device (e.g., a universal serial bus (USB) flash drive), and/or the like including any future device with software/application processing capabilities, and/or including any of the foregoing and/or any other device(s) implementing RFID, NFC, and/or IoT (Internet of Things) technologies.

The computer 150 is representative of, is substantially similar to, is embedded in, and/or complements the description of the server 110, the buyer computer 200, the seller computer 300, computing devices of the cloud databases 125, and/or computing devices of the cloud service 130. The computer 150 includes a processor(s) 160, a memory 170 storing an application 175, an input/output module (or I/0 module 180), and an interface 185. The processor 160 is wired and/or wirelessly connected to and/or communicatively connected to the memory 170 and the I/0 module 180. The I/O module 180 is wired and/or wirelessly connected to and/or communicatively connected to the interface 185 and the network 120.

The processor 160 includes any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor 160 may be any technically feasible hardware unit capable of processing data and/or executing software applications such as the application 175. Further, in the context of this disclosure, the computing elements shown in the computer 150 may correspond to a physical computing system (e.g., a local or networked computing device) or may be a virtual computing instance executing within a computing cloud.

Memory 170 includes a random-access memory (RAM) module, a read-only memory (ROM) module, a flash memory unit, a hard disk, magnetic disks, optical disks, magneto-optical disks, a mass storage device, a database, and/or any other type of memory unit or combination thereof. Processor 160 and I/O module 180 are configured to read instructions and/or data from and write instructions and/or data to memory 170. Memory 170 stores various software programs that can be executed by processor(s) 160 and application data associated with said software programs, including software that runs methods, steps, and processes such as the software, methods, steps, and/or processes described in this disclosure. The various software programs and the associated application data include the application 175.

The application 175 is configured to implement aspects described herein. The memory 170, the databases 115, the cloud service 130, and/or the cloud databases 125 store various data accessible by the application 175. According to one or more aspects, the application 175 may include software elements corresponding to one or more of the various aspects described herein. For example, application 175 may be implemented in various aspects using any desired technology and/or programming language, scripting language, and/or combination of programming languages and/or scripting languages and/or technologies (e.g., C, C++, C#, Dart, Flutter, PHP, JAVA®, JAVASCRIPT®, PERL®, Solidity, Smart Contracts, NFT's, blockchain, public electronic ledgers, centralized electronic ledgers, quantum blockchain, Metaverse technologies, and/or the like). Furthermore, the code, instructions, data, functionality, and/or results from processing and/or execution of the application 175 can vary according to the person or use of the system, the data available, the device and/or user running the application (for example, the application 175 in the server 110, the buyer computer 200, and the seller computer 300, may have different code or different executed portions of code), the role of the user and/or the device (for example, the user of the buyer computer 200 using the buyer computer 200 to buy a product then using the buyer computer 200 for selling or exchanging a product), and/or the like. As another example, the application 175 includes an artificial intelligence module.

The artificial intelligence module may contain, call, implement, and/or be implemented as one or more of a reactive machine, a limited memory machine, a theory of mind machine, a self-aware machine, an artificial narrow intelligence machine, an artificial general intelligence machine, an artificial super intelligence machine, machine learning structures and/or algorithms (including supervised learning, unsupervised learning, reinforcement learning, semi-supervised learning, self-supervised learning, multi-instance learning, inductive learning, deductive learning, transductive learning, multi-task learning, active learning, online learning, transfer learning, ensemble learning, regression, linear regression, logistic regression, classification, decision tree, SVM, Naïve Bayes, kNN, K-Means, random forest, dimensionality reduction, gradient boosting, GBM, XGBoost, Light GBM, CatBoost, and/or the like), a neural network (including a deep neural network, a feedforward network, a multilayer perceptron, a convolutional neural network, a radial basis functional neural network, a recurrent neural network, a long short-term memory, sequence-to-sequence, a modular neural network, and/or the like), and/or the like. The artificial intelligence module learns and/or is trained with user data as input and labeled data as output. According to one or more aspects, the artificial intelligence model of the artificial intelligence module learns and/or is trained at least with user behavior, searches, performance, items characteristics, prices, trends, churns as input and smart-matching results, tailored experience, advanced forecasting and predictive features as output (the inputs and/or outputs being collected data). In operation, to generate smart matching and predictive results as output from the artificial intelligence model and/or the artificial intelligence module, the collected data is sent (programmatically and/or via user command) to the artificial intelligence model and/or the artificial intelligence module and executing the artificial intelligence model and/or the artificial intelligence module. It should be understood in this specification and the claims that artificial intelligence model also refers to the module, and that artificial intelligence module also refers to the model. The artificial intelligence module enhances features, functionality and increase performance of the system via implementation of natural language processing, machine learning from previous searches and/or post and/or listings, predictive text, autocorrect, visual and voice recognition for searches and/or to include listings and/or requests and/or trades, and/or the like. The application 175, via the artificial intelligence module, generates smart-matching results by assigning different weights to specific requirements of a request and/or listing in to assign priority to the most important parameters (or preferred parameters) over less consequential parameters, wherein the assigning of different weights is based on user preferences and/or behavior, user's previous behavior, individually and/or as a selected group, location, season, etc. Advanced forecasting and inventory management is calculated based on concluded sales transactions, trends, actual demand in the platform (Buyers Matrix/requests) and projections.

The I/O module 180 provides the hardware, firmware, and/or software for the computer 150 to interact with other components and devices, including the interface 185, the network 120, other devices connected to the network 120, and/or the like. According to one or more aspects, the I/O module 180 can be connected to other devices, either wired or wirelessly, including input peripherals such as keyboards, microphones, cameras, and/or the like. According to one or more aspects, the I/O module 180, automatically and/or manually via user input through the interface 180 and/or via the network 120, requests, obtains, gets, posts, puts, creates, reads, updates, and/or deletes any information and/or data in the databases 115, the cloud databases 125, the cloud service 130, and/or other computers (such as the server 110, the buyer computer 200, and/or the seller computer 300). The processor 160, through the I/O module 180, actuates, creates, generates, sends, and/or receives signals and/or data to and/or from the network 120 and/or the interface 185. The I/O module 180 is configured to allow data to be exchanged between the computer 150 and other devices attached to a network 120, such as other computer systems, cloud services, remote databases, the cloud databases 125, the cloud service 130, the buyer computer 200, the seller computer 300, and/or the like. According to one or more aspects, the 1/0 module 180 supports communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol, including WAN, LAN, Wi-Fi®, Bluetooth®, and/or the like.

The interface 185 includes devices capable of providing input, such as a keyboard, a mouse, a smart pen, a touch-sensitive screen, a touchscreen, a camera, buttons, a microphone, a headphone, a headset, photosensors, biosensors, haptic sensors, and so forth, as well as devices capable of providing output, such as a display device, a touch-sensitive screen, a speaker, headphone, a headset, touchscreen, haptic transducer, LED's, and so forth. Additionally, interface 185 may include devices capable of both receiving input and providing output, such as a touchscreen, a universal serial bus (USB) port, and so forth. Interface 185 may be configured to receive various types of input from a user, such as verbal commands, typed input, gestures, sounds, and so forth, and to also provide various types of output to the user, such as displayed digital images, digital videos, sound, text, alarms, reminders, haptic sensations, and so forth. According to one or more aspects, interface 185 is embedded and/or integrated with the computer 150. For example, the computer 150 may have the interface 185 on the housing that encloses the computer 150.

The databases 115, the cloud databases 125, the cloud service 130, the server 110, the buyer computer 200, and/or the seller computer 300 can be local, remote, cloud-based, shared, dedicated, and/or the like. The databases 115, the cloud databases 125, and/or the cloud service 130 can be or include a database, a data warehouse, a data lake, a data repository, electronic ledger storage, a file storage, RAM, ROM, flash memory, and/or the like. The databases 115, the cloud databases 125, and/or the cloud service 130 can be or include any database technologies and/or any database management system (DBMS), including hierarchical, network, relational, object-oriented, sql, no-sql, graph, ER model, and/or document databases and/or DBMSs, and/or the like.

The network 120 includes any technically feasible type of communications network that allows data to be exchanged between the computer 150 and external entities or devices, such as a web server, another networked computing device, the server 110, the databases 115, the cloud databases 125, the cloud service 130, the buyer computer 200, the seller computer 300. For example, network 120 may include a centralized and/or decentralized networks, wide area network (WAN), a local area network (LAN), a wireless (WiFi) network, Bluetooth Metaverse network, and/or the Internet, among others. According to one or more aspects, the I/0 module 180 is not directly connected to one or more elements, parts, components, devices and/or networks. According to one or more aspects, the I/0 module 180 connects wirelessly to the to one or more elements, parts, components, devices and/or networks through the network 120.

Also, any connection may be associated with a computer-readable medium. For example, if the application 175 and/or data associated with or operated by the application 175 is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

According to one or more aspects, the online matching system 100 is world-wide-web (www) based, and the server 110 is a web server delivering HTML, XML, JSON, data, web pages, etc., to computing devices. According to one or more aspects, a client-server architecture may be implemented, in which a network server executes enterprise and custom software, exchanging data with custom client applications running on the computing device.

Referring back to FIG. 1-A, the online matching system 100 is shown to include the server 110 and the databases 115. The server 110 is wired and/or wirelessly connected to and/or communicatively connected to the databases 115. While FIG. 1-A shows the online matching system 100 enclosing the server 110 and the database 115, the online matching system 100 also includes the components and/or aspects of the cloud databases 125, the cloud service 130, the network 120, the buyer computer 200, and/or the seller computer 300 that run the application 175 (or a version or part of the application 175), that store and/or interact with data used by the application 175, or that otherwise interact with the server 110, the database 115, and/or any other component or aspect of the online matching system 100.

The databases 115 reside in a computer system, database system, one or more servers, and/or the like. According to one or more aspects, part of or all of the databases 115 reside in the server 110. According to one or more aspects, part of or all of the data used by the application 175 is in the server 110, the databases 115, the cloud databases 125, the cloud service 130, the buyer computer 200, and/or the seller computer 300.

The application 175 operates using product and/or service parameters and/or images stored in the databases 115, the cloud databases 125, the cloud service 130. In operation, the application 175 handles, inter alia, requests and listings. Requests include the information relating to or describing an intention or desire to purchase a product and/or service that at least partially meets the parameters included in the request. Listings include the information relating to or describing an intention or desire to sell a product and/or service that has the parameters included in the listing and/or exchange a product and/or service that at least partially meets the parameters included in the listing with a product and/or service that has the parameters included in the listing. The parameters are descriptive information and aspects of the products and/or services that can be used to compare products and/or services with each other, compare requests with products and/or services, compare listings with products and/or services, compare request with listings, compare listings with requests, and/or the like. Parameters include product and/or service title, product and/or service image, price, category, brand, size, quantity, condition, color, shipping method, expiration date, acceptance of similar items, exchange interests parameters, and whether a posted listing is negotiable, and/or the like. According to one or more aspects, parameters also include product and/or service specific characteristics. Product and/or service specific characteristics, or product and/or service characteristics, are parameters that are associated with a product and/or service based on the product and/or service type or category. The product and/or service types or categories include any possible characterization of a product and/or service, such as a product being categorized as a vehicle, a car, a boat, a household article, a clothing article, and so forth, and a service being categorized as an online service, a commercial service, in person service, a professional service, and so forth. The application determines a matching percentage based on the comparison of one or more parameters between products and/or services. The term “specification” is used interchangeably with the term “parameter” in this specification, including modifications and plural forms of the terms.

The server 110 handles the internet and/or network communications from the cloud databases 125, the cloud service 130, the buyer computer 200, and/or the seller computer 300. The cloud databases are databases located outside of the immediate physical infrastructure of the server 110, whether as a remote secondary location, a backup database, and/or as part of a cloud service such as cloud service 130. The cloud service 130 is any networked, online, internet, and/or web service that may be implemented to execute part or all of the application 175, handle and/or store the data accessed by the application 175, via provisioning software, Software-as-a-Service (SaaS), platform, Platform-as-a-Service (PaaS), infrastructure, Infrastructure-as-a-Service (IaaS), artificial intelligence models and/or processing, Artificial Intelligence-as-a-Service(AIaaS), and/or other technologies, such as Amazon Web Services (AWS®), Microsoft® Azure®, Google Cloud Platform (GCP®), Snowflake®, Heroku Netlify®, DigitalOcean®, IBM® Cloud, Oracle® Cloud Infrastructure, and/or the like. In operation, the server 110 (and/or, as provided according to implementations of the online matching system 100 and/or the execution of the application 175, the databases 115, the cloud databases 125, and/or the cloud service 130) communicates and interacts with the buyer computer 200 and the seller computer 300 to enable the online matching system 100 while executing the application 175. There can be multiple buyer computers 200 and/or seller computers 300 accessing multiple servers 110 that from part of the online matching system 100. The server 110 provides the webpages, website, web application, data, system access, and/or functionality of the online matching system 100 to the buyer computer 200 and the seller computer 300.

A computer, such as computer 150, can be a buyer computer 200 and/or a seller computer 300. A computer, such as computer 150, that accesses the online matching system to buy is a buyer computer 200. A computer, such as computer 150, that accesses the online matching system to sell is a seller computer 300. If a person with a computer such as computer 150 uses the person's computer to access the online matching system 100 as a buyer, that person's computer is the buyer computer 200; but if that same person later uses the same computer to access the online matching system 100 as a seller, then that same computer is now the seller computer 300. Likewise, if a person with a computer such as computer 150 uses the person's computer to access the online matching system 100 as a seller, that person's computer is the seller computer 300; but if that same person later uses the same computer to access the online matching system 100 as a buyer, then that same computer is now the buyer computer 200. Whether a computer is a buyer computer 200, a seller computer 300, or both depends on the use and the processes being run buy the application 175 and/or the online matching system 100.

To enable the reader to obtain a clear understanding of the technological concepts described herein, the following processes describe specific steps performed in a specific order. However, one or more of the steps of a particular process may be rearranged and/or omitted while remaining within the contemplated scope of the technology disclosed herein. One or more processes and/or steps thereof, may be combined, recombined, rearranged, omitted, or executed in parallel to create different process flows that are within the contemplated scope of the technology disclosed herein. While the processes below may omit or briefly summarize some of the details of the technologies disclosed herein for clarity, the details described in the paragraphs above may be combined with the process steps described below to get a more complete and comprehensive understanding of these processes and the technologies disclosed herein.

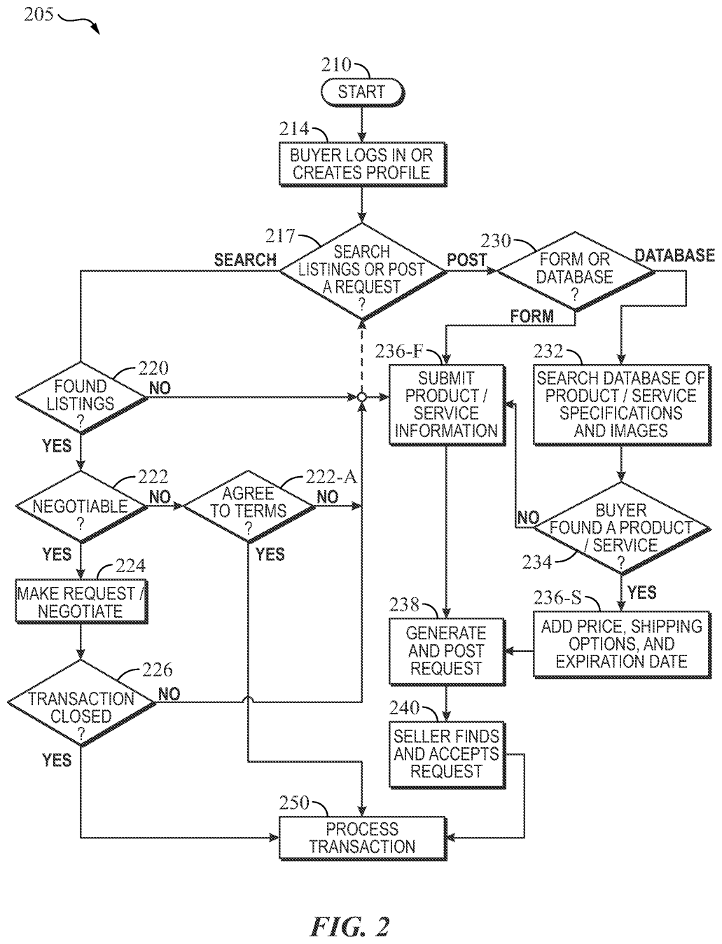

FIGS. 2, 3, and 4 illustrate various processes executable by and/or in the online matching system 100. It will be apparent to those with ordinary skill in the art which types of users (employees, staff, administrators, buyers, sellers, non-users browsing the website of the online matching system 100, and so forth) and/or the role of the devices accessing the online matching system 100 and/or executing the application 175 or part of the application 175 on devices, the devices then being a buyer computer 200, a seller computer 300, or both.

FIG. 2 illustrates a buying process 205. The buying process 205 starts at step 210, where a user who is a buyer, or intending to access the system as a buyer, turns on or starts the buyer computer 200, and/or accesses the online matching system 100 through the buyer computer 200. The buyer computer 200 may open a client application and/or an internet browser to visit a webpage, website, and/or web application of the online matching system 100. The client application is the application 175 (or part of the application 175) that, when executed by the server 110 and/or the buyer computer 200 (or the seller computer 300), the appropriate aspects of the online matching system 100 are available through the buyer computer 200 (such as the homepage or log-in page of the website for the application 175, screens showing data and/or aspects and functions of the online matching system 100, and/or the like). In step 214, the buyer logs in the online matching system 100 and/or creates a new account and/or profile in the online matching system 100. According to one or more aspects, a user may register as a user (being a buyer or seller depends on the use of the online matching system 100, the user having access to any appropriate request, direct buy, selling, and exchange aspects), a buyer (can only make requests and/or direct buys), a seller (can only make selling listings, exchange listings, and/or both), or as both buyer and seller (online matching system distinguishes users as buyers or sellers while accepting a user can be both, such that being a buyer or seller depends on the use of the online matching system 100). Once the buyer is logged-in, the process moves on to step 217, where the online matching system 100 displays or provides options for the buyer to search for a product and/or service (“direct buy”), or to post a request for a product and/or service (“request”). According to one or more aspects, once the buyer is logged-in, the process moves on to step 217, where the online matching system 100 displays or provides options for the buyer (or user) to direct buy, to request, to list a product and/or service for sale (“selling”), and/or to exchange products and/or services (“exchange”). The buyer (or a user in a buyer role) inputs a command for searching (direct buy) or for posting a request. The buyer computer 200 receives and processes the direct buy or request posting command from the buyer. If the buyer chooses direct buy, the application 175 receives a command for direct buy and causes the process 205 to move to step 220.

In step 220, the buyer searches for listings selling products and/or services. The buyer searches by input into the online matching system 100, through the buyer computer 200, one or more words, terms, phrases, parameters, and/or images descriptive and/or identifying the desired product and/or service. If the buyer does not find the desired product and/or service, the buyer has the option to keep searching or cause the process 205 to move to step 236-F, where the buyer can submit product and/or service information for a request, as further discussed below. According to one or more aspects, if the buyer does not find the desired product and/or service, the buyer has the option to cause the process 205 to go back to step 217 to do a new search or to post a request, to keep searching (stay in step 220), and/or cause the process 205 to move to step 236-F.

If the buyer finds a listing that satisfies the buyer's requirements or parameters, the process 205 moves to step 222, where the online matching system 100 determines (for example, via the processor 160 executing the application 175) whether the terms of listing found by the buyer are negotiable. If the terms are not negotiable, the process 205 moves to step 222-A. If the buyer does not agree to the terms of the listing for the product and/or service, the buyer inputs a command indicating that the buyer does not agree to the terms, causing the process 205 to move to step 236-F, where the buyer can submit product and/or service information for a request, as further discussed below. According to one or more aspects, if the buyer does agree to the terms of the listing for the product and/or service, the buyer has the option to cause the process 205 to go back to step 217 to do a new search or to post a request, to go back and reevaluate the terms (stay in step 222), go back to step 220 to search for other listings, and/or cause the process 205 to move to step 236-F. If the buyer does agree to the terms of the listing for the product and/or service, the buyer inputs a command indicating that the buyer does agree to the terms, causes the closing of the transaction, and causing the process 205 to move from step 222-A to step 250 to process the transaction, as further discussed below.

If the terms are negotiable, the process 205 moves to step 224. In step 224, the buyer inputs terms or parameters desired for the product or service, received by the application 175 through the buyer computer 200. The application 175 generates a negotiation request based on the parameters and sends the negotiation request to a seller that listed the product and/or service under negotiation. The seller can accept, reject, or counteroffer the negotiation request. If the seller accepts the negotiation request, the process 205 moves to step 226 and the transaction is closed. If the seller rejects the negotiation request, then the transaction not closed, so the buyer may accept the rejection and move to step 226 or may input new desired parameters and the application 175 generates a new negotiation request based on the new desired parameters and sends the new negotiation request to the seller, and the seller can accept, reject, or counteroffer the new negotiation request. If the seller counteroffers the negotiation request, the buyer may accept the counteroffer, closing the transaction and moving the process 205 to step 226, or the buyer may change the desired parameters and the application 175 generates a new negotiation request based on the new parameters and sends the new negotiation request to the seller, and the seller can accept, reject, or counteroffer the new negotiation request. According to one or more aspects, the buyer may at any point stop negotiations and/or accept or reject the original terms of the listing (not shown in FIG. 2), which would be procedurally equivalent to moving to step 222-A.

Back in step 217, if the buyer chooses to post a request instead of searching for a product and/or service listing, the application 175 receives a command for request posting and the process moves on to step 230. In step 230, the process 205 provides the buyer with the option to fill and submit a form for a generating a product request or to search a database for the product and/or service specification and images, which are stored in a database such as databases 115, cloud databases 125, the cloud service 130, and/or the like.

At step 230, if the application 175, via the buyer computer 200, receives a command to search a database for the product and/or service using specifications and images, the process 205 goes to step 232. In step 232, the process 205 displays fields for price, shipping options, and expiration date of the listing, the user inputs at least one desired parameter. The desired parameters are the desired price, the desired shipping options, and/or the desired expiration date. The application 175 receives the price, the shipping options, and/or the expiration date parameters. The application 175 compares the price, the shipping options, and/or the expiration date parameters with the parameters of the products and/or services listed for sale that are stored in the databases 115, the cloud databases 125, the cloud service 130, and/or the like. Based on the comparison of the price, the shipping options, and/or the expiration date parameters, the application 175 determines which products and/or services listed for sale have parameters that most closely match the price, the shipping options, and/or the expiration date parameters received and calculates matching percentages. Matching percentages indicate how close is a listed product and/or service to the desired parameters. The application 175 causes the displaying (via the interface 185) of products and/or services listed for sale which best matched the desired parameters. The products and/or services listed for sale are displayed with the matching percentages. Thus, the buyer can search and browse for the products and/or services, the parameters of the products and/or services, and/or the images of the products and/or services displayed without filling any fields besides the desired parameters. According to one or more aspects, the desired parameters include price, shipping options, expiration date, category, brand, size, condition, quantity, color, shipping method, any other parameter mentioned herein, any other applicable parameter, and/or the like. According to one or more aspects, the buyer may at any point stop searching at step 232 enter commands for the process 205 to move back to step 230 or step 217.

Next, on step 234, the application 175, through the interface 185 of the buyer computer 200, receives a command to select a product and/or service found by the buyer (when the buyer finds a product and/or service) or a command to generate a form with the desired parameters from the buyer (when the buyer has not found a product and/or service). If the application 175, via the buyer computer 200, receives a command to generate a form with the desired parameters, the process 205 goes to step 236-F.

Back at step 230, if the application 175, via the buyer computer 200, receives a command to fill and submit a form, the process 205 goes to step 236-F. In step 236-F, the application 175 causes the displaying (via the interface 185) of a product and/or service request form filled at least partially with received parameters, if any, from step 220, from step 222-A, from step 226, from step 230, or from step 234. The request form provides fields and/or access to fields for all parameters. Once the form is completed (whether partially or completely), the buyer can input a command to submit the form via the interface 185. The application 175, via the buyer computer 200, receives the command to submit the form. Based on the command to submit the form, the application 175 stores the information and/or parameters of the form (the request parameters) and causes the process 205 to move to step 238.

Back at step 234, if the application 175, via the buyer computer 200, receives a command to select a product and/or service found by the buyer, the process 205 moves to step 236-S. In step 236-S, the buyer may input additional and/or required parameters to partially or fully complete a request (request parameters) via the interface 185, wherein the request parameters match the parameters of the selected product and/or service required for closing a transaction. The parameters of a selected product and/or service required for closing a transaction are those parameters that have to be established and agreed upon for closing the transaction, such as price, payment terms, shipping options, expiration date (if any, limiting the time for a seller to accept the request), and/or the like. With the request parameters stored, the process 205 moves from step 236-S to step 238.

At step 238, the application 175 generates a request based on the request parameters from step 236-F or step 236-S. Note that request parameters from step 236-F are preferred or required parameters not tied to any particular product and/or service listing, while the request parameters from step 236-S are intended to match at least one product and/or service listing. Thus, when the application 175 generates a request based on the request parameters from 236-S, the seller behind receives a notification that a request has been posted that matches and/or is directed to the product and/or service listing of the seller. On the seller side, when the buyer is at step 238, the seller is at step 334 waiting for a request and moves through step 336 into step 338, as further discussed below.

Next, in step 240, a seller, via the application 175 and/or the seller computer 300, finds and accepts the request. Following the distinction between step 236-F and step 236-S, if the request originated through step 236-S, the request includes information of the listing to which the request is responding. Otherwise, if the request originated through step 236-F, the request does not include information related to any particular listing. Once a seller accepts the request, the transaction is closed, and the process 205 moves to step 250.

In step 250, application 175 causes the process 205 to process, handle, and complete the transaction. According to one or more aspects, the application 175 verifies or determines whether the transaction is closed, and if closed, then moves on to process, handle, and complete the transaction. The transaction is closed when the buyer and the seller have agreed to the terms and the terms can no longer be changed or modified, nor can the request or the listing be deleted or withdrawn. With the buyer and the seller committed to the transaction, to process, handle, and complete the transaction, the process 205 handles the payment processing and any other instructions for payment, shipping, and/or delivery of the product and/or service.

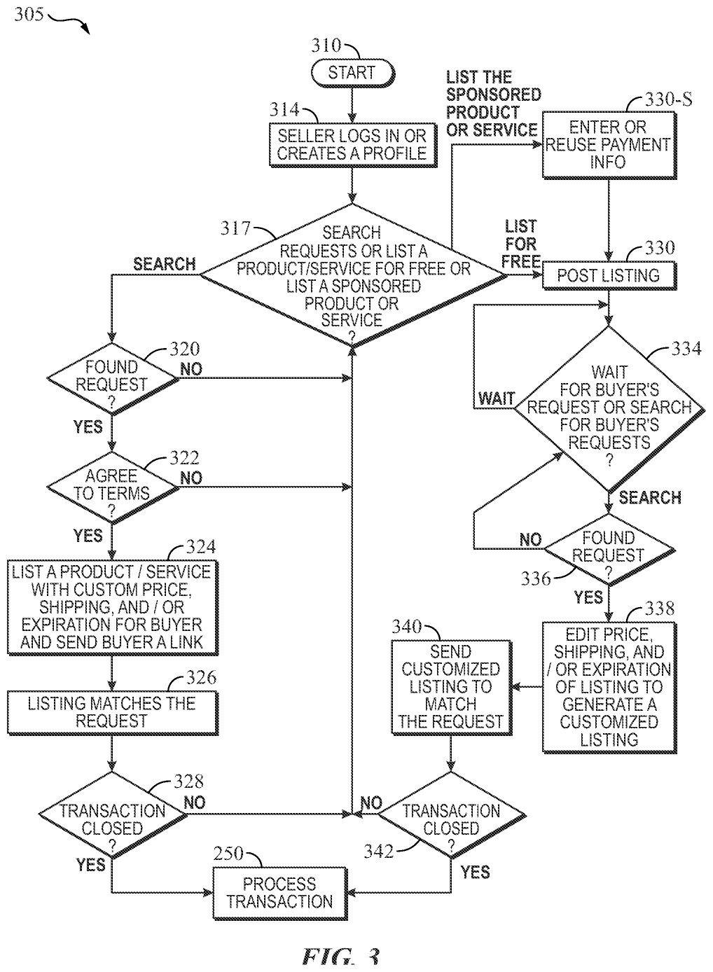

FIG. 3 illustrates a selling process 305. The selling process 305 starts at step 310, where a user who is a seller, or intending to access the system as a seller, turns on or starts the seller computer 300, and/or accesses the online matching system 100 through the seller computer 300. The seller computer 300 may open a client application and/or an internet browser to visit a webpage, website, and/or web application of the online matching system 100. In step 314, the seller logs in the online matching system 100 and/or creates a new account and/or profile in the online matching system 100. Once the seller is logged-in, the process moves on to step 317, where the online matching system 100 displays or provides options for the seller to search for a product and/or service request, to list a product and/or service for free, or to list a sponsored product and/or service. According to one or more aspects, once the seller is logged-in, the process moves on to step 317, where the online matching system 100 displays or provides options for the seller (or user) to direct buy, to request, to list for selling, and/or to exchange. The seller inputs a command to list for selling, the application 175 receives the command to list for selling, and the application 175 causes the online matching system 100, via the interface 185 of the seller computer 300, to display or provide options for the seller to search for a product and/or service request, to list a product and/or service for free, or to list a sponsored product and/or service. The seller (or a user in a seller role) inputs a command to search for a product and/or service request, to list a product and/or service for free, or to list a sponsored product and/or service. The seller computer 300, through the interface 185 and via the application 175, receives and processes the command from the seller to search for a product and/or service request, to list a product and/or service for free, or to list a sponsored product and/or service. If the seller chooses to search for a product and/or service request, the application 175 receives a command to search for a product and/or service request and causes the process 305 to move to step 320.

In step 320, the seller searches for requests to buy products and/or services. The seller searches by input into the online matching system 100, through the seller computer 300, one or more words, terms, phrases, parameters, and/or images descriptive of and/or identifying a desired request. A desired request is a request that has terms and/or parameters that the seller chooses to fulfill. If the seller does not find a desired request, the seller has the option to keep searching or cause the process 305 to move back to step 317.

If the seller finds a request that is a desired request for the seller, the process 305 moves from step 320 to step 322, where the seller provides an input and the application 175 receives a command indicating whether the seller agrees to the terms of the request. If the seller does not agree to the terms of the request, the process 305 moves back to step 317. According to one or more aspects, if the seller does not agree to the terms of the request, the process 305 moves back to step 320 (not shown). If the seller agrees to the terms of the request, the process 305 moves to step 324.

In step 324, a custom listing is created to match the desired request. To create the custom listing, the seller inputs, and the application 175 receives, a custom price, custom shipping options, and/or a custom listing expiration date. According to one or more aspects, the create the custom listing, the seller inputs, and the application 175 receives, one or more parameters customized for the desired request. The seller inputs a command for a link to the custom listing to be sent to the buyer associated with the desired request. The application 175 receives the command to send the link to the custom listing to the buyer. The application 175 sends (or causes the online matching system 100 to send) the link to the custom listing to the buyer based on the command to send the link to the custom listing to the buyer. According to one or more aspects, when the application 175 receives the command to send the link to the custom listing to the buyer, the process 305 moves to step 326.

In step 326, the application 175 determines whether the custom listing matches the desired request based on a comparison of the parameters of the custom listing with the parameters of the desired request. If the custom listing matches the desired request, the application 175 determines that the transaction is closed, which corresponds for the buyer to step 240 of process 205. If the custom listing does not match the desired request, the application 175 moves from step 326 to step 328 and waits for a response from the buyer to the link to the custom listing (accepting, rejecting, or counteroffering the custom listing) and/or the expiration of the custom listing. If the response accepts the custom listing, the transaction is closed and the process 305 moves to step 250. If the response rejects the custom listing, the transaction is not closed and the process 305 moves to step 317. If the response is a counteroffer, the application 175 handles the counteroffer as a desired request and the process 305 moves back to step 322 (not shown). As discussed above, in step 250, application 175 causes the process 205 to process, handle, and complete the transaction.

According to one or more aspects, in step 326, the application 175 calculates a matching percentage between the desired request and the custom listing. The application 175 determines whether the custom listing matches the desired request based on whether the matching percentage meets or exceeds a preestablished threshold. The application 175 sends the link to the custom listing to the buyer if the custom listing matches the desired request. If the custom listing does not match the desired request, the application 175 displays or provides a notification through the interface 185 of the seller computer 300 indicating that custom listing does not match the desired request and provides an opportunity for the seller to modify the custom listing. The seller responds to the notification by entering, through the seller computer 300, a command to go back to step 324 or to go forward with sending to the buyer the link to the custom listing. The application 175 receives the command to go back to sept 324 or to go forward with sending to the buyer the link to the custom listing. Based on the command to go back to sept 324 or to go forward with sending to the buyer the link to the custom listing, the application 175 causes the process 305 either to go back to sept 324 or to send to the buyer the link to the custom listing and move to step 328.

Back at step 317, if the seller chooses to list a product and/or service for free, the application 175 receives a command to list a product and/or service for free and causes the process 305 to move to step 330. If the seller chooses to list a sponsored product and/or service, the application 175 receives a command to list a sponsored product and/or service and causes the process 305 to move to step 330-S.

In step 330-S, the seller enters and the application 175 receives payment information. Payment information includes the name of the payor, billing information, authorization to charge, amount paid and/or to be paid, pending balances, discounts and discount codes, credit card information, connection to payment services (Stripe®, PayPal Venmo®, Plaid®, and/or the like), ACH information, electronic transfer information, and/or the like. The application 175 stores the payment information based on an authorization from the seller. The payment information is stored in the server 110, the databases 115, the cloud databases 125, the cloud service 130, and/or the seller computer 300. The application 175 causes the online matching system 100 to charge the seller based on the payment information. Once payment is processed, the process 305 moves from step 330-S to step 330.

In step 330, the seller enters parameters of the product and/or service to be listed. The application 175 receives the parameters of the product and/or service to be listed. The application 175 generates a product and/or service listing based on the parameters of the product and/or service to be listed. Once the product and/or service listing is generated, the application 175 posts the product and/or service listing. The application 175 associates the seller with the product and/or service listing and stores the product and/or service listing (including all associations, images, and/or all parameters) in the server 110, the databases 115, the cloud databases 125, and/or the cloud service 130. With the product and/or service listing stored and posted, the process 305 moves to step 334.

In step 334, the seller searches through posted requests or waits for a direct buy from a buyer (as in steps 222 and 222-A) or a request for negotiation (as in steps 222 and 224) from a buyer. If seller chooses to wait, or stops searching and waits, the seller may step away from the seller computer 300 and/or log-off from the online matching system 100 and the listing will remain posted. With the listing posted and the seller waiting, a buyer may be in step 220 of process 205, find the listing of the seller, the process 205 moving to step 222, and engage in a direct buy as in step 222-A or engage in a request for negotiation as in at step 224, so that the process 305 is diverted to match the steps of process 205 for the seller side, and the seller engages as required for negotiations and/or for closing the transaction as described above for FIG. 2 (not shown in FIG. 3).

If the seller chooses to search through posted requests at step 334, the process 305 moves to step 336. In step 336, the seller may either not find a request, decide to stop searching, and wait, thus moving the process back to step 334 as discussed above, or find a request that is (or becomes) a desired request. The application 175 receives a command to fulfill the desired request, moving the process from step 336 to step 338.

In step 338, a custom listing is generated to match the desired request. To generate the custom listing, the seller inputs, and the application 175 receives and generates the custom listing based on a custom price, custom shipping options, and/or a custom listing expiration date. After the custom listing is generated, the process moves to step 340.

In step 340, the seller inputs a command for a link to the custom listing to be sent to the buyer associated with the desired request. The application 175 receives the command to send the link to the custom listing to the buyer. The application 175 sends (or causes the online matching system 100 to send) the link to the custom listing to the buyer based on the command to send the link to the custom listing to the buyer. According to one or more aspects, when the application 175 receives or sends the command to send the link to the custom listing to the buyer, the process 305 moves to step 342.

In step 342, the application 175 waits for and receives a response from the buyer to the link to the custom listing (accepting, rejecting, or counteroffering the custom listing) and/or the expiration of the custom listing. If the response accepts the custom listing, the transaction is closed and the process 305 moves to step 250. If the response rejects the custom listing, the transaction is not closed and the process 305 moves to step 338. If the response is a counteroffer, the application 175 handles the counteroffer as a desired request and the process 305 moves back to step 322 (not shown). As discussed above, in step 250, application 175 processes, handles, and completes the transaction. According to one or more aspects, steps 324, 326, and/or 328 are similar or identical to steps 338, 340, and/or 342, respectively. According to one or more aspects, steps 338, 340, and/or 342 are similar or identical to steps 324, 326, and/or 328, respectively.

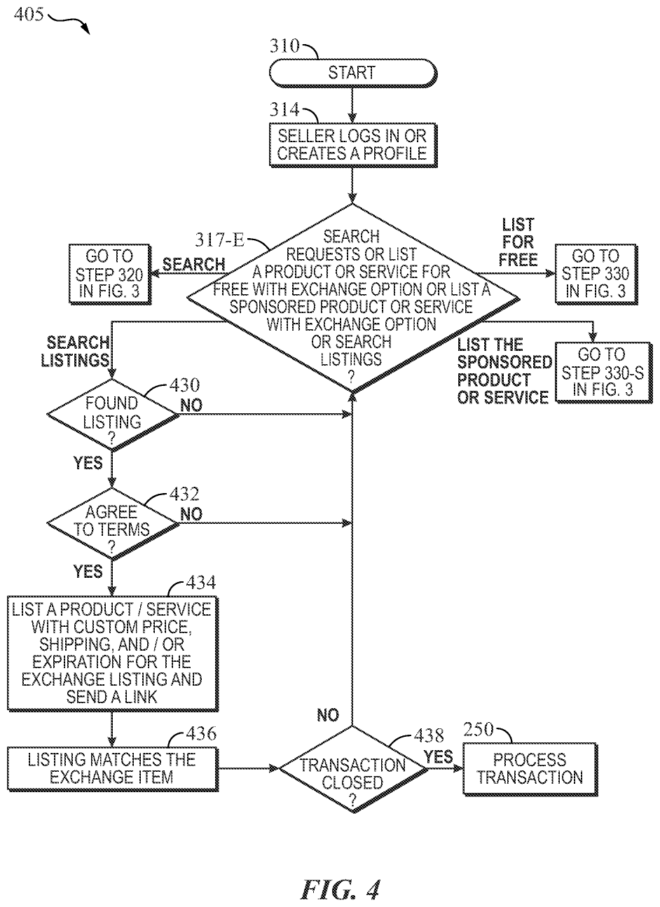

FIG. 4 illustrates an exchange process 405. The process 405 starts like the process 305, at step 310, which moves on to step 314. The process 405 moves from step 314 to step 317-E in the same manner in which the process 305 moves from step 314 to step 317. Step 317-E incorporates the aspects of step 317 of process 305. In step 317-E, the online matching system 100 displays or provides options for the seller (or user) to direct buy, to request, to list for selling, and/or to exchange. The seller inputs a command to list for exchange, the application 175 receives the command to list for exchange, and the application 175 causes the online matching system 100, via the interface 185 of the seller computer 300, to display or provide options for the seller to search for a product and/or service request for exchange, to list a product and/or service for exchange for free, to list a sponsored product and/or service for exchange, or search listings for exchange. The seller (or a user in a seller role) inputs a command to search for a product and/or service request, to list a product and/or service for free, to list a sponsored product and/or service, or to search for a product and/or service listing. Note that when generating a request or a listing, the request or the listing includes an exchange parameter. The exchange parameter indicates whether the request and/or listing cannot be fulfilled with an exchange or can be optionally or exclusively fulfilled with an exchange.

The seller computer 300, through the interface 185 and via the application 175, receives and processes the command from the seller. If the seller chooses to search for a product and/or service listing for exchange, the application 175 receives a command to search for a product and/or service listing and causes the process 405 to move from step 317-E to step 430. Steps 430, 432, 434, 436, and/or 438 are similar or identical to the steps 320, 322, 324, 326, and/or 328, respectively, but instead of searching for requests the seller is searching for listings and the corresponding listings optionally and/or exclusively accepting exchanges of products and/or services. Thus, in step 434, setting a custom price is optional when the listing is not exclusively for exchange. According to one or more aspects, setting a custom price is not available when the desired request or the desired listing is exclusively for exchange. A desired listing is a listing that has terms and/or parameters, including for optional or exclusive fulfillment via exchange, that the seller chooses to fulfill. If the transaction is closed at step 438, the process 405 moves to step 250 and processes the transaction, which may include processing the exchange of products and/or services, with or without payment.

If the seller chooses to search for a product and/or service request for exchange, the application 175 receives a command to search for a product and/or service request and causes the process 405 to move from step 317-E to step 320. Steps 430, 432, 434, 436, and/or 438 are similar or identical to the steps 320, 322, 324, 326, and/or 328, respectively, but with the steps 320, 322, 324, 326, and/or 328 processing requests that optionally and/or exclusively accept exchanges of products and/or services.

Note the similarity of the process 405 at step 430 with the process 405 moving to step 320. The difference is that in step 320, the process 405 (now moving through steps of process 305) involves searching for requests (now with optional or exclusive exchange fulfillment), while in step 430, the process 405 involves searching for listings. Therefore, the comparison and matching is between the listing found at step 430, or desired listing, and the comparison and matching in step 436 is between two listings.

If the seller chooses to list a product and/or service for exchange for free, the application 175 receives a command to search for a product and/or service request and causes the process 405 to move from step 317-E to step 330, but with the listing including an exchange parameter indicating the listing can be fulfilled optionally or exclusively via exchange.

If the seller chooses to list a sponsored product and/or service for exchange, the application 175 receives a command to search for a product and/or service request and causes the process 405 to move from step 317-E to step 330-S, but with the listing including an exchange parameter indicating the listing can be fulfilled optionally or exclusively via exchange.

In view of processes 205, 305, and/or 405, the manner in which a request, a direct buy, a selling, and an exchange operate is observed from the perspective of the online matching system 100. From a user perspective, a request to buy may be started by a buyer that posts a request to buy first with a seller finding the request through a search, or by a seller that post a listing first with a buyer receiving a link sent by the seller offering the seller listing to the buyer, wherein the seller listing is a customized listing when one or more parameters of the posted seller listing are edited before sending. Note that when a buyer posts a request one or more sellers may find the request and attempt to fulfill by sending a link to a listing or to a customized listing.

In a direct buy, the buyer searches for products and/or services listed by a seller. The buyer may find a non-negotiable listing, select the product and/or service of that listing, and directly go to checkout. The buyer may find a negotiable listing and choose not to negotiate, select the product and/or service of that listing, and directly go to checkout; alternatively, the buyer may choose to negotiate by making an offer and communicating back and forth with the seller through the application 175. If the buyer does not find a product and/or service, the buyer may choose to post a request in the online matching system 100. Note that in a direct buy multiple buyers may search, find, and close a transaction of one posted listing from a seller.

In selling, a buyer posts a request to buy and, before the buyer finds a matching listing, the seller finds the request through a search. The seller chooses to fulfill this desired request, generates a new custom listing matching the request, and sends a message with a link offering the new listing to the buyer. Note that the seller can also post this listing for other buyers to find, optionally changing the price and/or other parameters.

In an exchange, a first seller posts a first product and/or service listing with an exchange parameter (allowing optional or exclusive exchange), and either a second seller posts a second product and/or service listing with an exchange parameter that is matched to the first product and/or service listing, or a buyer or a third seller search first for products with an exchange parameter and make a third product and/or service listing with an exchange parameter. Note that, through exchange workflows (for example, through the exchange process 405), two sellers (two users intending and/or registered as sellers) may engage in an exchange transaction.

According to one or more aspects, a user may input commands, and the application 175 receives commands and/or signals based on those commands via the interface 185 and/or the I/O module 180, by typing, scanning bar codes of products, scanning NFC' s and/or RFID's, using images from gallery or from built in cameras (for example, in smartphones and other similar devices), voice recognition, virtual assistants, and/or the like.

According to one or more aspects, the application 175, through the interface 185, displays one or more fields and/or lists, wherein the fields can be filled out by a user and/or the lists include one or more

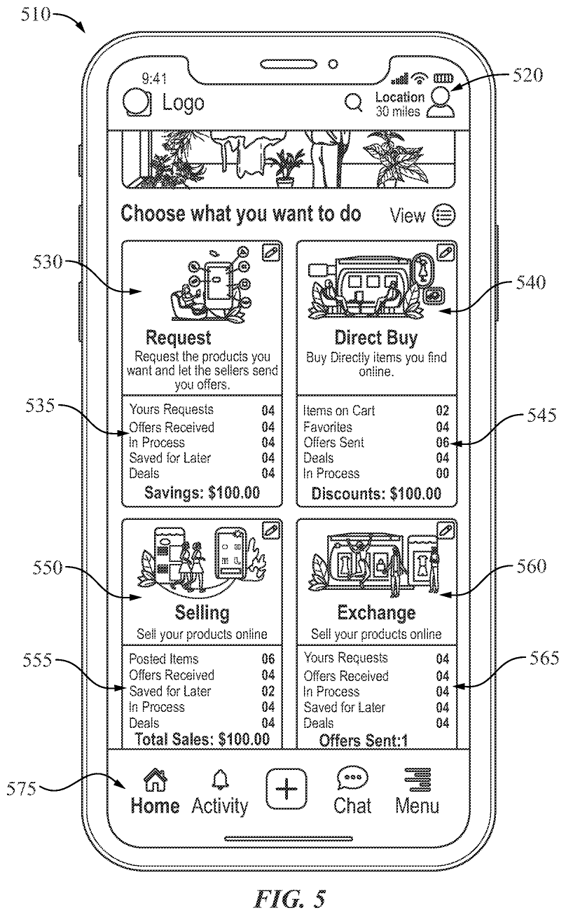

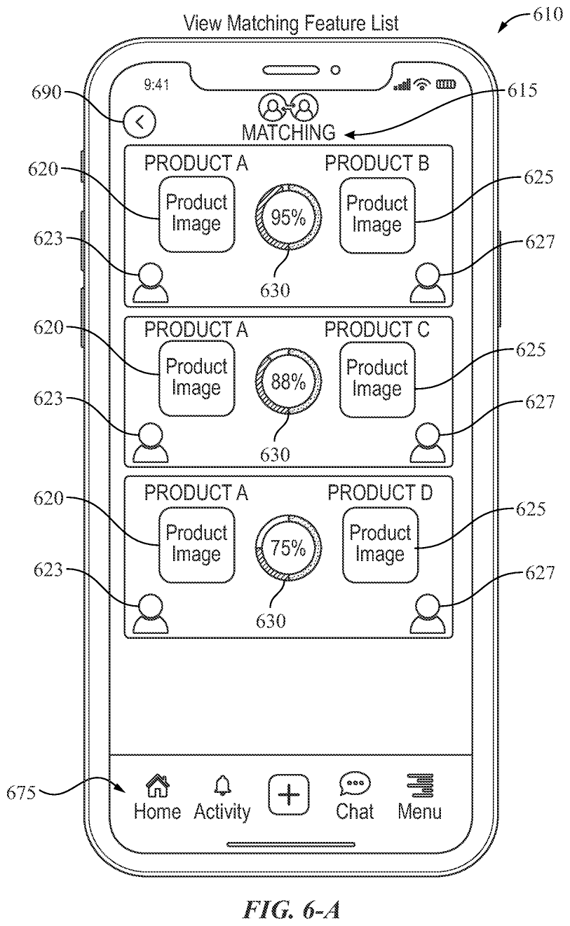

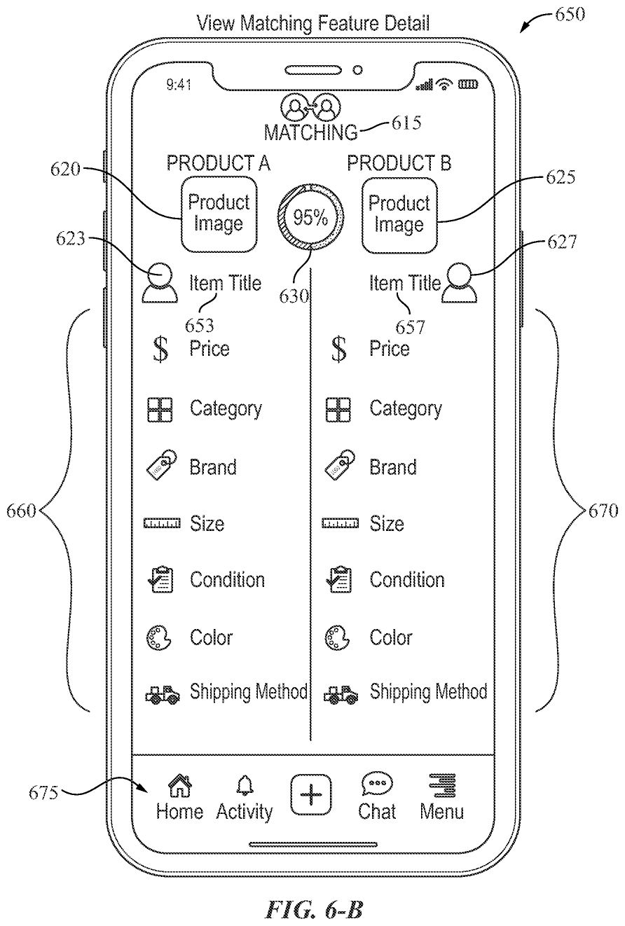

FIGS. 5, 6-A, and 6-B illustrate various screenshots displayed by the application 175 through an interface 185. FIG. 5 illustrates a home screen 510 for a user of the online matching system 100. The home screen 510 includes a user identifier 520, a request button 530, a request dashboard 535, a direct buy button 540, a direct buy dashboard 545, a selling button 550, a selling dashboard 555, an exchange button 560, an exchange dashboard 565, and a navigation bar 575. The request button 530, the direct buy button 540, the selling button 550, and the exchange button 560, when clicked by the user, cause the application 175 to display screens corresponding to the role of the user, according to the processes 205, 305, and/or 405, as discussed herein. According to one or more aspects, the request button 530 is the same as the request dashboard 535, the direct buy button 540 is the same as the direct buy dashboard 545, the selling button 550 is the same as selling dashboard 555, and an exchange button 560 is the same as the exchange dashboard 565.

The request dashboard 535 displays the user's number of requests, the number of offers received, the number of requests in process, the number of requests saved for later, the number of deals available, the amount of savings made by the user through requests, and/or the like.

The direct buy dashboard 545 displays the number of items in the cart, the number of favorite products and/or services in listings, the number of offers sent, the number of deals, the number of direct buys in process, and the monetary amount of discounts received through direct buys.

The selling dashboard 555 displays the number of items posted for selling, the number of offers received, the number of listing saved for later, the number of sales through listings in process, the number of deals, and the total monetary amount in sales.

The exchange dashboard 565 displays the number of request, the number of offers received, the number of exchanges in process, the number of requests and/or listings with an exchange parameter that are saved for later, the number of exchange deals, and the number of offers sent.

All the information in the request dashboard 535, the direct buy dashboard 545, the selling dashboard 555, and/or the exchange dashboard 565 is stored in, updated in, and/or read from the server 110, the databases 115, the cloud databases 125, and/or the cloud service 130 by the application 175.

The navigation bar 575 has a home button, an activity button, a chat button, and a menu button. The home button takes the user back to the home screen 510 when clicked by sending a home signal to the application 175. The application 175 receives the home signal and, in response to the home signal, causes the display of the home screen 510. Note that the display is at the home screen 510 and the home button is bolded in comparison to the other buttons.

The activity button, when clicked, sends an activity signal to the application 175. The application 175 receives the activity signal and, in response to the activity signal, causes the display of a screen showing any notifications and activities in the account of the user and/or activities from other users and/or the application 175.

The chat button, when clicked, sends a chat signal to the application 175. The application 175 receives the chat signal and, in response to the chat signal, causes the display of a screen showing all chats or conversation threads with other users and enabling the user to continue communications through those conversation threads and/or to create new conversation threads with one or more of the other users.

The menu button, when clicked, sends a menu signal to the application 175. The application 175 receives the menu signal and, in response to the menu signal, causes the display, in a new screen or on top of the current screen, of a horizontal, vertical, or diagonal banner that display links to other screen, such as a settings screen to modify settings, an account screen to review or edit user information and/or passwords application 175.

FIG. 6-A illustrates a matching feature list screen 610. The matching feature list screen 610 includes a screen title 615 that reads “MATCHING,” one or more comparison boxes, a navigation bar 675 (which may be identical or functionally identical to the navigation bar 575 of FIG. 5), and a back button 690. Each of the comparison boxes has a first product image 620 with a first product identifier above the product image 620, a first user identifier 623 (which may be identical to or different from the user identifier 520 of FIG. 5), a second product image 625 with a second product identifier above the second product image 625, a second user identifier 627, and a match percentage indicator 630. The first product image 620 and the second product image 625 show images representative of the corresponding products and/or services. The first product image 620 of a first comparison box may be the same or different than the first product image 620 of a second comparison box and/or a third comparison box, and so forth. The second product image 625 of a first comparison box may be the same or different than the second product image 625 of a second comparison box and/or a third comparison box, and so forth. The back button 690, when clicked, moves the display to the previous screen. In each comparison box, the match percentage indicator 630 shows the matching percentage between the first product and the second product associated with the corresponding comparison box. The match percentage indicator 630 is a percentage number with a circular indicator bar surrounding the match percentage indicator 630 and filled to an amount corresponding to the corresponding percentage number. Note that, since the screen is not the home screen, the navigation bar 675 does not have the home button bolded. If a user clicks any of the one or more comparison boxes, the application 175 causes the display of matching feature details screen 650 as shown in FIG. 6-B.

FIG. 6-B illustrates a matching feature details screen 650. The matching feature details screen 650 includes a screen title 615 that reads “MATCHING,” one or more comparison boxes, and a navigation bar 675. The matching feature details screen 650 also includes the first product image 620 with the first product identifier above the first product image 620, the first user identifier 623, a first item title 653 below the first product image 620, the second product image 625 with a second product identifier above the second product image 625, a second user identifier 627, a second item title 657 below the second product image 625 and a match percentage indicator 630, all corresponding to the comparison box clicked on the matching feature list screen 610 of FIG. 6-A. A first list of parameters 660 is located below the first item title 653. The first list of parameters 660 shows a list of the parameters of the product and/or service corresponding to the first product image 620. A second list of parameters 670 is located below the second item title 657. The second list of parameters 670 shows a list of the parameters of the product and/or service corresponding to the second product image 625.

It will be understood that it would be unduly repetitious and obfuscating to describe and illustrate every combination and subcombination of the elements and the aspects described. Accordingly, all elements can be combined in any way and/or combination, and the present specification, including the drawings, shall be construed to constitute a complete written description of all combinations and subcombinations of the elements and of the aspects described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that what has been particularly shown and described hereinabove is not limiting and is not to be interpreted as foreclosing modifications and variations. A variety of modifications and variations are possible in light of the above teachings without departing from the following claims.

What is claimed is:

1. A process for online transactions, the process comprising:
receiving request parameters;
receiving first listing parameters;
generating a request based on the request parameters;
generating a first listing based on the first listing parameters;
determining that the request matches the first listing by comparing the request parameters with the first listing parameters; and
notifying a buyer associated with the request or a first seller associated with the first listing, or both the buyer and the first seller, that the request matches the first listing.

2. The process for online transactions of claim 1, the process further comprising:
storing the request parameters and the first listing parameters in one or more databases.

3. The process for online transactions of claim 1,
wherein the determining that the request matches the listing by comparing the request parameters with the listing parameters comprises calculating a matching percentage between the request parameters and the listing parameters and comparing the matching percentage to a threshold.

4. The process for online transactions of claim 1, the process further comprising:
receiving second listing parameters that allow exchanges;
receiving third listing parameters that allow exchanges;
receiving customized third listing parameters that allow exchanges;
generating a second listing based on the second listing parameters;
generating a third listing based on the third listing parameters;
generating a customized listing based on the customized third listing parameters; and
sending a link to a second seller associated with the second listing,
wherein the link points to the customized listing, and
wherein the customized third listing parameters match the second listing parameters.

5. The process for online transactions of claim 1, wherein the first listing is a customized listing.

6. The process for online transactions of claim 1, the process further comprising:
posting the request or posting the first listing.

7. The process for online transactions of claim 1, the process further comprising:
displaying a screen comprising at least one of the following: a request dashboard, a direct buy dashboard, a selling dashboard, and an exchange dashboard.

8. The process for online transactions of claim 1, the process further comprising:
generating a customized listing having at least one customized listing parameter that is different from at least one corresponding parameter of the first listing parameters.

9. An online matching system comprising:
a buyer computer, a seller computer, and a server communicatively connected to each other through a network;
a memory storing an application;
a processor which executes the application to cause the system to:
receive request parameters;
receive first listing parameters;
generate a request based on the request parameters;
generate a first listing based on the first listing parameters;
determine that the request matches the listing by comparing the request parameters with the first listing parameters; and
notify a buyer associated with the request or a first seller associated with the first listing, or both one the buyer and the first seller, that the request matches the first listing.

10. The online matching system of claim 9, wherein the processor executes the application to further cause the system to:
store the request parameters and the first listing parameters in one or more databases.

11. The online matching system of claim 9,
wherein to determine that the request matches the listing by comparing the request parameters with the listing parameters comprises to calculate a matching percentage between the request parameters and the listing parameters and to compare the matching percentage to a threshold.

12. The online matching system of claim 9, wherein the processor executes the application to further cause the system to:
receive second listing parameters that allow exchanges;
receive third listing parameters that allow exchanges;
receive customized third listing parameters that allow exchanges;
generate a second listing based on the second listing parameters;
generate a third listing based on the third listing parameters;
generate a customized listing based on the customized third listing parameters; and
send a link to a second seller associated with the second listing,
wherein the link points to the customized listing, and
wherein the customized third listing parameters match the second listing parameters.

13. The online matching system of claim 9,
wherein the first listing is a customized listing.

14. The online matching system of claim 9, wherein the processor executes the application to further cause the system to:
post the request.

15. The online matching system of claim 9, wherein the processor executes the application to further cause the system to:
post the first listing.

16. The online matching system of claim 9, wherein the processor executes the application to further cause the system to:
generate a customized listing having at least one customized listing parameter that is different from at least one corresponding parameter of the first listing parameters.

17. The online matching system of claim 9, wherein the processor executes the application to further cause the system to:
display a screen comprising at least one of the following: a request dashboard, a direct buy dashboard, a selling dashboard, and an exchange dashboard.

18. A computer readable medium having computer readable instructions executable by a processor which, when executed, performs a process for generating requests and listings, the process comprising:
receiving request parameters;
receiving first listing parameters;
generating a request based on the request parameters;
generating a first listing based on the first listing parameters;
determining that the request matches the listing by comparing the request parameters with the first listing parameters; and
notifying a buyer associated with the request or a first seller associated with the first listing, or both one the buyer and the first seller, that the request matches the first listing.

19. The computer readable medium of claim 18, the process further comprising:
display a screen comprising at least one of the following: a request dashboard, a direct buy dashboard, a selling dashboard, and an exchange dashboard.

20. The computer readable medium of claim 18, the process further comprising:
storing the request parameters and the first listing parameters in one or more databases.

21. The computer readable medium of claim 20, the process further comprising:
receiving second listing parameters that allow exchanges;
receiving third listing parameters that allow exchanges;
receiving customized third listing parameters that allow exchanges;
generating a second listing based on the second listing parameters;
generating a third listing based on the third listing parameters;
generating a customized listing based on the customized third listing parameters; and
sending a link to a second seller associated with the second listing,
wherein the link points to the customized listing, and
wherein the customized third listing parameters match the second listing parameters.

22. The computer readable medium of claim 20,
wherein the first listing is a customized listing.
